(19) United States
(12) Patent Application Publication
(10) Pub. No.: US 2010/0232659 A1
(43) Pub. Date: Sep. 16, 2010

(54) METHOD FOR FINGERPRINT TEMPLATE SYNTHESIS AND FINGERPRINT MOSAICING USING A POINT MATCHING ALGORITHM

(75) Inventors: Mark Rahmes, Melbourne, FL (US); Liam M. Mayron, Melbourne, FL (US); Josef Allen, Melbourne, FL (US)

Correspondence Address: HARRIS CORPORATION;C/O FOX ROTHSCHILD, LLP, 997 Lenox Drive, Building 3, Lawrenceville, NJ, 08543-5231, US

(73) Assignee: Harris Corporation, Melbourne, FL (US)

(21) Appl. No.: 12/402,723

(22) Filed: Mar. 12, 2009

(51) Int. Cl. G06K 9/00

(52) U.S. Cl. 382/125

(57) ABSTRACT

A method and system for fingerprint template synthesis from multiple fingerprint images is provided. A first set of minutiae points is extracted from a first fingerprint image. A second set of minutiae points is extracted from a second fingerprint image. The orientation is calculated for a plurality of minutiae points selected from the first set of minutiae points based on the first fingerprint image. Simulated points are added to the first set of minutiae points, wherein simulated points are created based on the location and orientation of minutiae points in the plurality of minutiae points. The first set of minutiae points and the second set of minutiae points are registered and the first set of minutiae points and the second set of minutiae points are combined.

### BACKGROUND OF THE INVENTION

1. Statement of the Technical Field

The inventive arrangements relate to biometric systems, and more particularly to fingerprint template synthesis and fingerprint mosaicing.

2. Description of the Related Art

Biometric systems are used to identify individuals based on their unique traits. Biometrics are useful in many applications, including security and forensics. Some physical biometric markers include facial features, fingerprints, hand geometry, and iris and retinal scans. A biometric system can authenticate a user or determine the identity of sampled data by querying a database.

There are many advantages to using biometric systems. Most biometric markers are present in most individuals, unique between individuals, permanent throughout the lifespan of an individual, and easily collectable. However, these factors are not guaranteed. For example, surgical alterations may be used to change a biometric feature such that it does not match one previously collected from the same individual. Furthermore, different biometric features can change over time.

Fingerprints are considered a robust form of biometric identification. A fingerprint is an impression of the raised friction ridges on the epidermis. Fingerprints have lasting permanence and are unique to an individual, making them an ideal means for identification. Fingerprints may be collected from naturally deposited imprints on surfaces. Fingerprints are currently the contact biometric of choice and are likely to remain so for the foreseeable future. Fingerprints are less intrusive than certain other biometrics, for example iris and DNA, though more intrusive than facial recognition or voice prints.

The use of fingerprints as a form of biometric identification began with manual methods for collecting fingerprints and evaluating matches. The “ink technique” of pressing and rolling an individual subject's inked finger on a card is still in use today. One way to produce digital images of fingerprints is to then scan these cards. Solid-state fingerprint readers have become common in automated authentication systems. Currently, they are often the only practical solution. Solid-state fingerprint sensors work based on capacitance, thermal, electric field, laser, radio frequency and other principles. Fingerprint sensors typically generate 2-dimensional fingerprint images, although some fingerprint sensors generate 3-dimensional fingerprint images.

Even though fingerprints are unique across individuals, they share common features. These key features have been used in fingerprint verification systems for identification purposes. Level 1 features of fingerprints include loops, whorls and arches formed by the ridges. These features describe the overall shape followed by the ridges. Level 2 features of fingerprints, or minutiae, are irregularities or discontinuities in the ridges. These include ridge terminations, bifurcations, and dots. Level 3 features of fingerprints include ridge pores, ridge shape, as well as scarring, warts, creases and other deformations.

Fingerprint enrollment associates fingerprint data with a specific user. Fingerprint recognition can be divided into verification and identification. In fingerprint verification, a fingerprint is used to verify the claimed identity of a user. In fingerprint identification, fingerprint data from an individual is compared to fingerprint data in a database to seek a match. It is common in the art to store only a fingerprint template rather than the full fingerprint image. A fingerprint template consists of key features extracted from the fingerprint, such as key minutiae points.

There are several complications in creating a fingerprint template. When the curved surface of a finger is pressed over a flat surface, uneven pressure will cause elastic skin deformations in the captured fingerprint reading. Other problems include incomplete readings due to poor contact and noise. Furthermore, for latent fingerprints (i.e. those produced unintentionally, such as fingerprints collected at a crime scene), the information available is often of considerably lower quality and information content. Multiple fingerprint images of the same finger may be collected and combined to overcome these issues.

Fingerprint mosaicing is a technique used to reconcile information presented by two or more fingerprint images. Mosaicing can be accomplished at the image level or the feature level. In image-based mosaicing, fingerprint images are reconciled into a single stitched fingerprint image before the extraction of features to synthesize a fingerprint template. In feature-based mosaicing, features are first extracted from each of the fingerprint images. Then, the features are reconciled, resulting in a synthesized fingerprint template combining the features from the separate fingerprint images. Image-based mosaicing is more computationally complex and is more prone to producing artifacts, resulting in false features being included in the final fingerprint template.

The iterative closest point (ICP) algorithm is a method used to register, or combine, fingerprint images or fingerprint feature sets. The ICP algorithm iteratively estimates the optimal transformation (translation and rotation) to register the original images or feature sets. It outputs a refined transformation which can be used combine the images or feature sets. Minutiae points are commonly used as the feature set in fingerprint templates. Minutiae points are described by an (x, y) position relative to the associated fingerprint image. Because each minutia is associated with a fingerprint ridge ending or bifurcation, a minutia orientation can be inferred for each minutia. Input for the standard ICP algorithm consists of point sets, not angles. Even though minutiae orientation information can provide information useful for registration, minutiae orientation has not been used with the ICP algorithm in fingerprint template synthesis.

### SUMMARY OF THE INVENTION

The invention concerns a method and system for fingerprint template synthesis from multiple fingerprint images. A first set of minutiae points is extracted from a first fingerprint image. A second set of minutiae points is extracted from a second fingerprint image. The orientation is calculated for a plurality of minutiae points selected from the first set of minutiae points based on the first fingerprint image. Simulated points are added to the first set of minutiae points, wherein simulated points are created based on the location and orientation of minutiae points in the plurality of minutiae points. The first set of minutiae points and the second set of minutiae points are registered. Finally, the first set of minutiae points and the second set of minutiae points are combined.

According to another aspect of the invention, the orientation is calculated for a plurality of minutiae points selected from the second set of minutiae points based on the second fingerprint image. Simulated points are added to the second set of minutiae points, wherein simulated points are created based on the location and orientation of minutiae points in the plurality of minutiae points.

According to another aspect of the invention, the iterative closest point (ICP) algorithm is selected to register the first set of minutiae points and the second set of minutiae points. Combining the first set of minutiae points and second set of minutiae points comprises rotating and translating minutiae points. The fingerprint template may include or exclude the simulated points.

According to another aspect of the invention, at least one fingerprint image is preprocessed to enhance ridge lines, and the ridge lines are used to calculate the orientation of minutiae points. Preprocessing may also comprise using inpainting techniques to detect and fill in voids.

According to another aspect of the invention, the simulated points are created based on the orientation and type of said minutiae points. The minutia point may be a ridge ending, in which case the orientation is the angle of a line of orientation connecting the ridge ending and an end point. The end point is determined by tracing the ridge line in a direction away from the ridge ending for a predetermined distance. Simulated points are created at selected pixels lying on the line of orientation between the ridge ending and the end point. The minutia point may be a bifurcation point, in which case the orientation of the bifurcation point is the angle of a line of orientation bisecting the angle between a first line and a second line. The first line connects the bifurcation point and a first end point determined by tracing a first ridge of the bifurcation in a direction away from the bifurcation point for a first predetermined distance. The second line connects the bifurcation point and a second end point determined by tracing a second ridge of the bifurcation in a direction away from the bifurcation point for a second predetermined distance. Simulated points are created at selected pixels lying on the line of orientation within a third predetermined distance of the bifurcation point.

According to another aspect of the invention, a method for fingerprint recognition from multiple fingerprint images is provided. A first fingerprint image and a second fingerprint image are obtained. A first set of minutiae points is extracted from the first fingerprint image and a second set of minutiae points is extracted from the second fingerprint image. The orientation is calculated for a plurality of minutiae points selected from the first set of minutiae points based on the first fingerprint image. Simulated points are added to the first set of minutiae points, wherein simulated points are created based on the location and orientation of minutiae points in the plurality of minutiae points. The first set of minutiae points and the second set of minutiae points are registered. Finally, the first set of minutiae points and the second set of minutiae points are combined. The resulting fingerprint template is compared to stored fingerprint templates to locate a match.

According to another aspect of the invention, the orientation may be calculated for a plurality of minutiae points selected from the second set of minutiae points based on the second fingerprint image. Simulated points are added to the second set of minutiae points, wherein simulated points are created based on the location and orientation of minutiae points in the plurality of minutiae points.

According to another aspect of the invention, a system for fingerprint enrollment comprises a fingerprint sensor, a computing means, and a computer-readable storage medium for storing the fingerprint template. The fingerprint sensor generates multiple fingerprint images of the same finger. The computing means synthesizes a fingerprint template from the multiple fingerprint images by extracting a first set of minutiae points from a first fingerprint image, extracting a second set of minutiae points from a second fingerprint image, calculating the orientation of a plurality of minutiae points selected from the first set of minutiae points, adding simulated points to the first set of minutiae points based on the location and orientation of the minutiae points in the plurality of minutiae points, registering the sets of minutiae points, and combining the sets of minutiae points into a fingerprint template. The fingerprint template is stored using the computer-readable storage medium.

According to another aspect of the invention, the computing means also calculates the orientation of a second plurality of minutiae points selected from the second set of minutiae points, and adds simulated points to the second set of minutiae points based on the location and orientation of the minutiae points in the second plurality of minutiae points.

According to another aspect of the invention, at least one of the fingerprint sensor, the computing means, and the computer-readable storage medium is a solid-state device.

### BRIEF DESCRIPTION OF THE DRAWINGS

FIG. 1 is a block diagram of a computer system that may be used in embodiments of the invention.

FIG. 2 is flowchart of image-based mosaicing.

FIG. 3 is a flowchart of feature-based mosaicing.

FIG. 4 is a flowchart of a method of fingerprint template synthesis according to embodiments of the invention.

FIG. 5a is a representation of a fingerprint image before preprocessing.

FIG. 5b is a representation of a fingerprint image after preprocessing.

FIG. 6 is a representation of minutiae types.

FIG. 7 is a diagram of the calculation of orientation for a ridge ending.

FIG. 8 is a diagram of the calculation of orientation for a bifurcation.

FIG. 9 is a diagram useful for understanding the iterative closest point (ICP) algorithm.

FIG. 10 is a flowchart of fingerprint recognition according to embodiments of the invention.

### DETAILED DESCRIPTION OF THE PREFERRED EMBODIMENTS

### Image-Based and Feature-Based Mosaicing

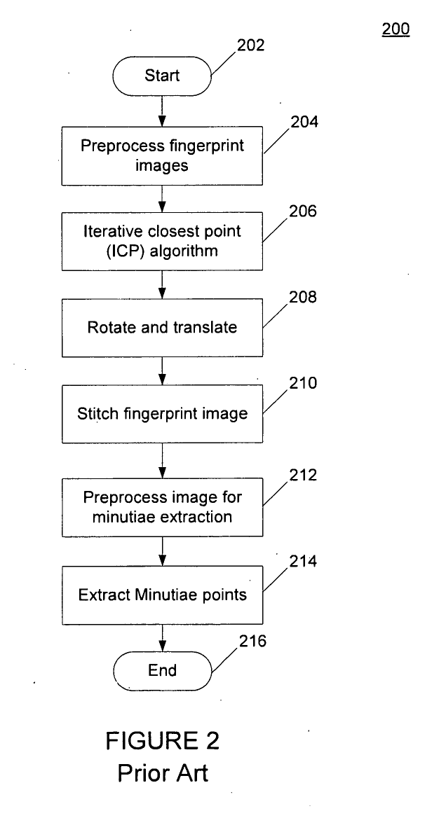

Image-based and feature-based mosaicing have been used in the prior art for fingerprint template synthesis. FIG. 2 is a flowchart that outlines the image-based mosaicing process described in A. Jain, A. Ross, “Fingerprint mosaicking,” IEEE International Conference on Acoustics, Speech, and Signal Processing, 2002, vol. 4, pp. 4064-67 (2002).

Process 200 in FIG. 2 begins at step 202 and continues with step 204. In step 204, two fingerprint images are preprocessed. The method continues to step 206, where the iterative closest point (ICP) algorithm is used to register the two fingerprint images. The method continues to step 208, where one image is rotated and translated according to the results of the ICP algorithm. The method continues to step 210, where the two images are stitched into one fingerprint image. The method continues to step 212, where the combined fingerprint image is preprocessed to facilitate minutiae extraction. Typically, to preprocess a fingerprint image, the image is binarized and the fingerprint ridges are thinned. Various algorithms are known in the art for preprocessing a fingerprint image before feature extraction. The method continues to step 214, where minutiae points are extracted. In step 216, the process terminates.

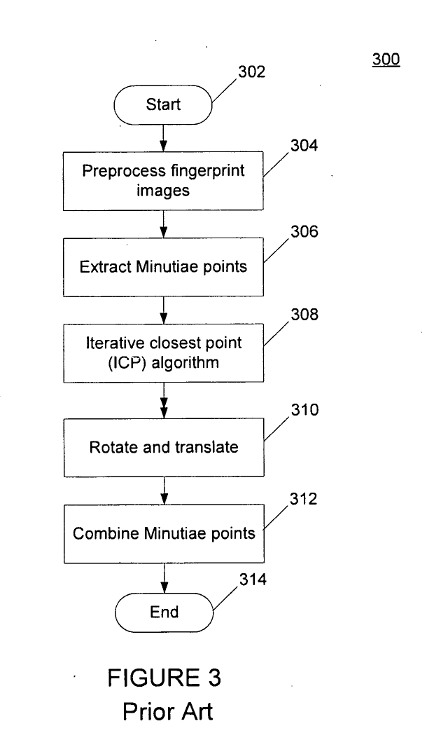

FIG. 3 is a flowchart that outlines the feature-based mosaicing process described in Y. S. Moon, et al., “Template synthesis and image mosaicking for fingerprint registration: an experimental study,” IEEE Conference on Acoustics, Speech, and Signal Processing, 2004, vol. 5, pp. 409-12, (2004).

Process 300 in FIG. 3 begins at step 302 and continues with step 304. In step 304, two fingerprint images are preprocessed for minutiae extraction. The method continues to step 306, where minutiae points are extracted from each fingerprint image. The method continues to step 308, where the ICP algorithm is used to register the two sets of minutiae points. The method continues to step 310, where one set of minutiae points is rotated and translated according to the results of the ICP algorithm. The method continues to step 312, where the minutiae points are combined to form a fingerprint template. In step 314, the process terminates.

It is noted that the orientation of the minutiae points is not used in the registration step of process 200 or process 300.

### Embodiments of the Invention

The invention will now be described more fully hereinafter with reference to accompanying drawings, in which illustrative embodiments of the invention are shown. This invention, may however, be embodied in many different forms and should not be construed as limited to the embodiments set forth herein. Accordingly, the present invention can take the form as an entirely hardware embodiment, an entirely software embodiment, or a hardware/software embodiment.

The present invention can be realized in one computer system. Alternatively, the present invention can be realized in several interconnected computer systems. Any kind of computer system or other apparatus adapted for carrying out the methods described herein is suited. A typical combination of hardware and software can be a general-purpose computer system. The general-purpose computer system can have a computer program that can control the computer system such that it carries out the methods described herein.

The present invention can take the form of a computer program product on a computer-usable storage medium (for example, a hard disk or a CD-ROM). The computer-usable storage medium can have computer-usable program code embodied in the medium. The term computer program product, as used herein, refers to a device comprised of all the features enabling the implementation of the methods described herein. Computer program, software application, computer software routine, and/or other variants of these terms, in the present context, mean any expression, in any language, code, or notation, of a set of instructions intended to cause a system having an information processing capability to perform a particular function either directly or after either or both of the following: a) conversion to another language, code, or notation; or b) reproduction in a different material form.

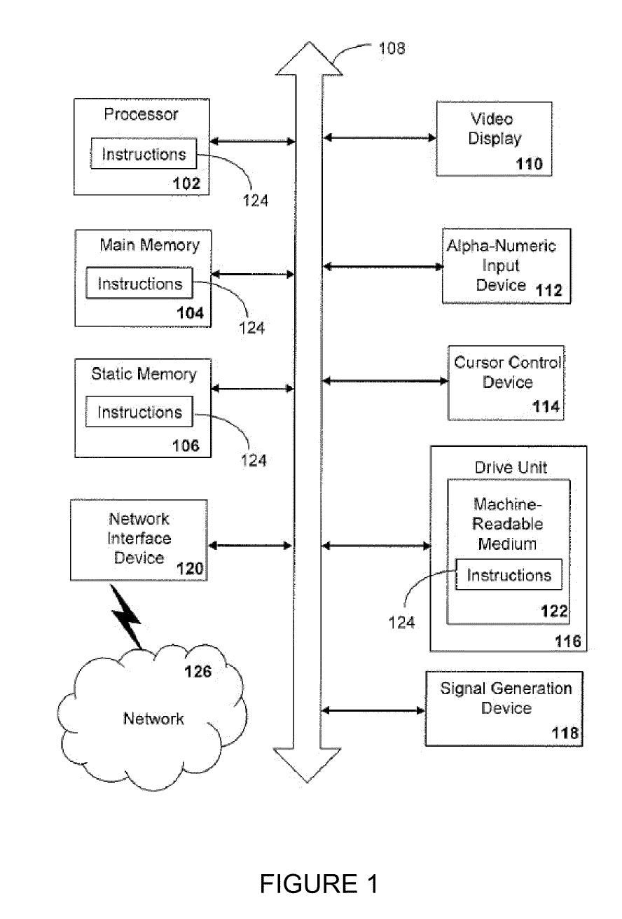

The computer system 100 of FIG. 1 can comprise various types of computing systems and devices, including a server computer, a client user computer, a personal computer (PC), a tablet PC, a laptop computer, a desktop computer, a control system, a network router, switch or bridge, or any other device capable of executing a set of instructions (sequential or otherwise) that specifies actions to be taken by that device. It is to be understood that a device of the present disclosure also includes any electronic device that provides voice, video or data communication. Further, while a single computer is illustrated, the phrase “computer system” shall be understood to include any collection of computing devices that individually or jointly execute a set (or multiple sets) of instructions to perform any one or more of the methodologies discussed herein.

The computer system 100 can include a processor 102 (such as a central processing unit (CPU), a graphics processing unit (GPU, or both), a main memory 104 and a static memory 106, which communicate with each other via a bus 108. The computer system 100 can further include a display unit 110, such as a video display (e.g., a liquid crystal display or LCD), a flat panel, a solid state display, or a cathode ray tube (CRT)). The computer system 100 can include an input device 112 (e.g., a keyboard), a cursor control device 114 (e.g., a mouse), a disk drive unit 116, a signal generation device 118 (e.g., a speaker or remote control) and a network interface device 120.

The disk drive unit 116 can include a computer-readable storage medium 122 on which is stored one or more sets of instructions 124 (e.g., software code) configured to implement one or more of the methodologies, procedures, or functions described herein. The instructions 124 can also reside, completely or at least partially, within the main memory 104, the static memory 106, and/or within the processor 102 during execution thereof by the computer system 100. The main memory 104 and the processor 102 also can constitute machine-readable media.

Dedicated hardware implementations including, but not limited to, application-specific integrated circuits, programmable logic arrays, and other hardware devices can likewise be constructed to implement the methods described herein. Applications that can include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the exemplary system is applicable to software, firmware, and hardware implementations.

In accordance with various embodiments of the present invention, the methods described below can be stored as software programs in a computer-readable storage medium and can be configured for running on a computer processor. Furthermore, software implementations can include, but are not limited to, distributed processing, component/object distributed processing, parallel processing, virtual machine processing, which can also be constructed to implement the methods described herein.

In the various embodiments of the present invention, a computer-readable storage medium containing instructions 124 or that receives and executes instructions 124 from a propagated signal so that a device connected to a network environment 126 can send or receive voice and/or video data, and that can communicate over the network 126 using the instructions 124. The instructions 124 can further be transmitted or received over a network 126 via the network interface device 120.

While the computer-readable storage medium 122 is shown in an exemplary embodiment to be a single storage medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure.

The term “computer-readable medium” shall accordingly be taken to include, but not be limited to, solid-state memories such as a memory card or other package that houses one or more read-only (non-volatile) memories, random access memories, or other re-writable (volatile) memories; magneto-optical or optical medium such as a disk or tape; as well as carrier wave signals such as a signal embodying computer instructions in a transmission medium; and/or a digital file attachment to e-mail or other self-contained information archive or set of archives considered to be a distribution medium equivalent to a tangible storage medium. Accordingly, the disclosure is considered to include any one or more of a computer-readable medium or a distribution medium, as listed herein and to include recognized equivalents and successor media, in which the software implementations herein are stored.

Those skilled in the art will appreciate that the computer system architecture illustrated in FIG. 1 is one possible example of a computer system. However, the invention is not limited in this regard and any other suitable computer system architecture can also be used without limitation.

Embodiments of the invention relate to methods for fingerprint template synthesis. The term “fingerprint template synthesis” as used herein refers to any process for creating a fingerprint template. Fingerprint template synthesis includes extracting data comprising features from at least one fingerprint image. Fingerprint template synthesis may include the combination of features extracted from multiple fingerprint images. The term “fingerprint template” as used herein refers to fingerprint data comprising a set of features associated with a fingerprint from one finger. In one embodiment of the invention, the features comprise minutiae points. The fingerprint data in a fingerprint template can be associated with one individual possessing the finger, and is therefore usable to identify that individual. The set of features comprising a fingerprint template may be extracted from one fingerprint image. The set of features may also be extracted from multiple fingerprint images associated with the finger. A fingerprint template may comprise features extracted from partial fingerprint images.

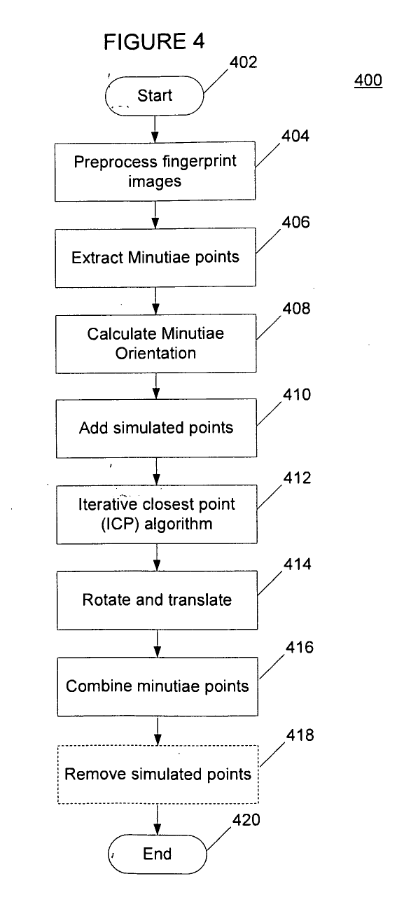

FIG. 4 is a flowchart useful for understanding synthesizing fingerprint templates according to embodiments of the invention. Process 400 in FIG. 4 begins at step 402 and continues with step 404. In step 404, at least one fingerprint image is preprocessed to facilitate minutiae extraction. The term “fingerprint image” as used herein refers to a digital image of a fingerprint. In one embodiment of the invention, two or more fingerprint images are preprocessed to facilitate minutiae extraction. A fingerprint image may come from various sources, such as a solid-state fingerprint reader, a digital scan of a manually collected fingerprint, such as a scan of a fingerprint collected from using the ink method, or a latent fingerprint. A fingerprint image may include a partial fingerprint image.

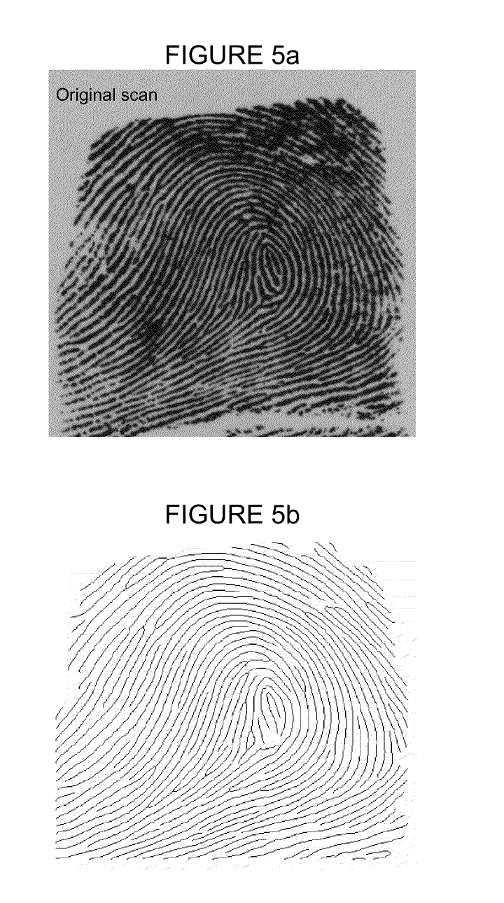

The term “preprocessing” as used herein refers to any sequence of mathematical or statistical calculations or transformations applied to an image. Preprocessing may be used in embodiments of the invention to facilitate the extraction of minutiae points from a fingerprint image. Preprocessing may refer to any combination of preprocessing steps. Preprocessing to facilitate minutiae extraction may include binarizing the fingerprint and/or thinning the ridges. In one embodiment of the invention, the fingerprint image is a grayscale fingerprint image and preprocessing the fingerprint image comprises binarizing the image, converting it into a black-and-white image. In one embodiment of the invention, preprocessing enhances the ridge lines to facilitate minutiae extraction and the calculation of orientation. This may involve thinning the fingerprint ridges. FIG. 5A is a representation of a fingerprint image before preprocessing. FIG. 5B is a representation of a fingerprint image after preprocessing according to one embodiment of the invention. In one embodiment of the invention, preprocessing includes using inpainting techniques to detect and fill in voids. Voids may be present in a fingerprint image due to natural features of a finger, such as scars or creases. Voids may also be present in a fingerprint image due to an incomplete reading, such as an incomplete reading by a 2-dimensional electronic fingerprint sensor or missing data in a latent fingerprint. Other image preprocessing steps, such as noise reduction, may also be employed.

Returning to process 400, the method continues to step 406, where minutiae points are extracted. The term “minutia point” as used herein refers to any point representation of the location of a minutia. For example, a minutia point may be a point representation of the location of a minutia with reference to a fingerprint image. In one embodiment, the point representation is a pixel location in a 2-dimensional fingerprint image. In another embodiment, the point representation is a 3-dimensional point with reference to a 3-dimensional fingerprint image. A set of minutiae points is extracted from each fingerprint image. In one embodiment of the invention, each set of minutiae points is associated with one fingerprint image. In one embodiment of the invention, a first set of minutiae points is extracted from a first fingerprint image and a second set of minutiae points is extracted from a second fingerprint image.

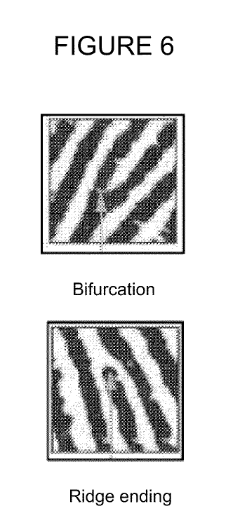

FIG. 6 show the fundamental types of minutiae: ridge endings and bifurcations. A ridge ending is the point at which a ridge terminates. A bifurcation is the point at which a single ridge splits into two ridges. Other features may be counted as minutiae points. These include what are considered compound minutiae: short ridges (aka islands and dots), lakes (aka enclosure), opposed bifurcations, bridges, double bifurcations, hooks (aka spurs) and bifurcations opposed with an ending. Henry C. Lee et al. Advances in Fingerprint Technology, 374, CRC Press (2d ed. 2001). In one embodiment of the invention, the fundamental types of minutiae points are extracted. In another embodiment of the invention, other selected types of minutiae points are also extracted. The sets of minutiae points may be determined by a computational or statistical evaluation of a preprocessed fingerprint image. In one embodiment of the invention, computational or statistical methods are used to refine the set of minutiae points by selecting key minutiae points to include in the set of minutiae points associated with a fingerprint image.

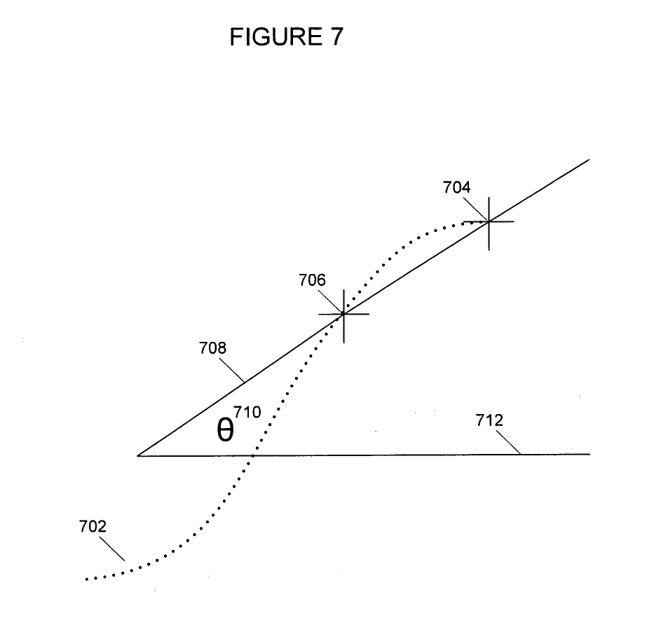

Returning to process 400, the method continues to step 408, where the orientation of minutiae are calculated. A minutia point may be associated with an orientation of the minutia represented by the minutia point. The orientation of a minutia point as used herein refers to an angle assigned to the minutia point. The angle may be calculated based on the fingerprint image, including other features surrounding the minutia point. For example, the angle may be calculated based on features determined to be fingerprint ridges in a fingerprint image. FIG. 7 is a diagram useful for understanding the calculation of the orientation of a ridge ending in one embodiment of the invention. Ridge line 702 ends at ridge ending 704. Endpoint 706 is determined by tracing ridge line 702 in a direction away from ridge ending 704 for a predetermined distance. In one embodiment of the invention, the predetermined distance is measured in pixels on the preprocessed fingerprint image. For example, the predetermined distance may be about 5 to 10 pixels. The orientation 710 of ridge ending 704 is determined by the angle of a line of orientation 708 which connects ridge ending 704 and endpoint 706. For example, the angle of line of orientation 708 may be determined with respect to reference line 712. In one embodiment of the invention, reference line 712 is any line parallel to the x axis of a 2-dimensional image. It would be understood by a person of skill in the art that orientation 710 may be defined with reference to a 2-dimensional fingerprint image, or in any other coordinate system used to describe the fingerprint image, such as a 3-dimensional fingerprint image scan.

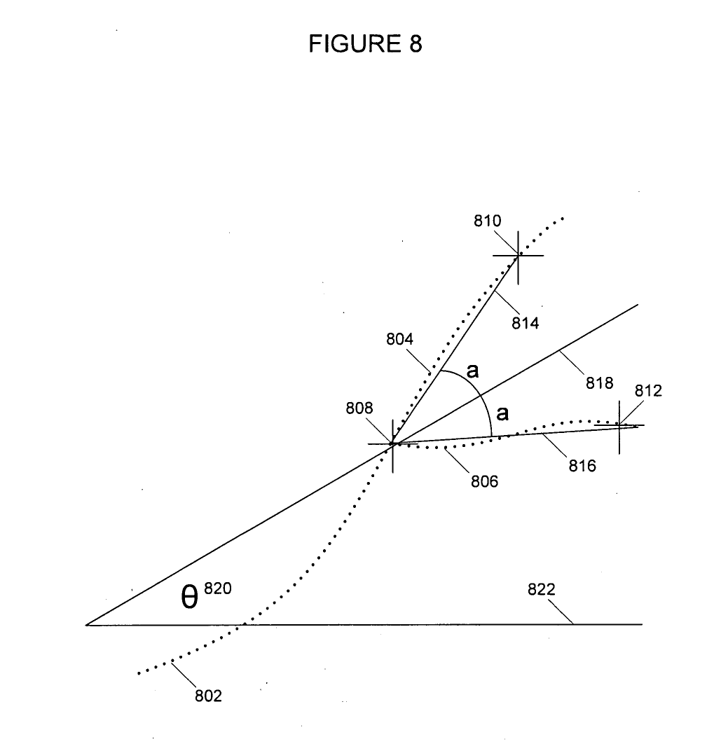

FIG. 8 is a diagram useful for understanding the calculation of orientation of a bifurcation in one embodiment of the invention. Ridge line 802 splits into a first ridge 804 and a second ridge 806 at bifurcation point 808. A first endpoint 810 is determined by tracing first ridge 804 in a direction away from bifurcation point 808 for a first predetermined distance. A second endpoint 812 is determined by tracing second ridge 806 in a direction away from bifurcation point 808 for a second predetermined distance. In one embodiment of the invention, the first predetermined distance and second predetermined distance is measured in pixels on the preprocessed fingerprint image. For example, the first predetermined distance and the second predetermined distance may be about 5 to 10 pixels. The first predetermined distance may be the same or different as the second predetermined distance. A first line 814 connects first endpoint 810 and bifurcation point 808. A second line 816 connects second endpoint 812 and bifurcation point 808. The orientation 820 of bifurcation point 808 is determined by the angle of a line of orientation 818 bisecting the angle formed by first line 814 and second line 816. For example, the angle of line of orientation 818 may be determined with respect to reference line 822. In one embodiment of the invention, reference line 822 is any line parallel to the x axis of a 2-dimensional image. It would be understood by a person of skill in the art that orientation 820 may be defined with reference to a 2-dimensional fingerprint image, or in any other coordinate system used to describe the fingerprint image, such as a 3-dimensional fingerprint image scan.

It may be appreciated by a person of ordinary skill in the art that embodiments of the invention include other methods to calculate the orientation of a minutia based on a fingerprint image. In one embodiment of the invention, orientation is calculated only for select minutiae points. For example, orientation may be calculated for only fundamental minutiae points. In one embodiment of the invention, orientation is calculated only for sets of minutiae points associated with a some of the fingerprint images. In another embodiment of the invention, orientation is calculated for the sets of minutiae points associated with all of the fingerprint images. Although the calculation of minutiae point orientation for bifurcations and ridge endings is described in reference to a 2-dimensional fingerprint image, one skilled in the art will appreciate that embodiments of the invention may be modified for use in 3-dimensional fingerprint images.

Returning to process 400, the method continues to step 410, where simulated points are added to at least one set of minutiae points based on the location and orientation of minutiae points. In one embodiment of the invention, simulated points are located to simulate orientation information for a minutiae point. This allows orientation information to be considered by a registration method which ordinarily considers only point location without considering point orientation. In one embodiment of the invention, simulated points are added to a set of minutiae points in close proximity to a minutiae point. For example, 5-10 simulated points may be added to a set of minutiae points to simulate the orientation information of one minutiae point. In one embodiment of the invention, simulated points are added along a line of orientation intersecting the minutiae point, where the line of orientation's angle is equal to the calculated orientation of the minutiae point. In this way, information about the orientation of a minutia point is added to a set of minutiae points in a way that a point registration method is designed to handle.

Referring to FIG. 7, in one embodiment of the invention, simulated points for a minutia point comprising a ridge ending 704 with orientation 710 are created at select pixels lying on line of orientation 708 between ridge ending 704 and endpoint 706. The select pixels may comprise all pixels on line of orientation 708 between ridge ending 704 and endpoint 706. Alternatively, the select pixels may comprise a selected subset of the pixels. Pixels may be selected at random, evenly distributed, or according to any other distribution.

Referring to FIG. 8, in one embodiment of the invention, simulated points for a minutia point comprising a bifurcation point 808 with orientation 820 are created at select pixels lying on line of orientation 818 within a third predetermined distance of bifurcation point 808. In one embodiment of the invention, the simulated points are located on line of orientation 818 in a direction towards the bifurcation (i.e. in the direction of first ridge 804 and second ridge 806). In another embodiment of the invention, the simulated points are located on line of orientation 818 away from the bifurcation (i.e. in the direction of ridge line 802). In another embodiment of the invention, the simulated points are centered around bifurcation point 808. The simulated points may also be distributed with respect to bifurcation point 808 in any other manner. In one embodiment of the invention, the third predetermined distance is about 5 to 10 pixels. The select pixels may comprise all pixels on line of orientation 818 within the second predetermined distance. Alternatively, the select pixels may comprise a selected subset of the pixels. Pixels may be selected at random, evenly distributed, or according to any other distribution.

It will be appreciated by a person of ordinary skill in the art that, in other embodiments of the invention, many ways of calculating simulated points may be employed for each type of minutiae. In one embodiment of the invention, simulated points are added only for select minutiae points. For example, simulated points may be added for only fundamental minutiae points. In one embodiment of the invention, simulated points are added only for a subset of fingerprint images. It would be understood by a person of skill in the art that the simulated points may be defined by a pixel coordinate in reference to a 2-dimensional fingerprint image, or in any other coordinate system used to describe the location of minutiae points in a set of minutiae points associated with a fingerprint image. Although the calculation of minutiae point orientation for bifurcations and ridge endings is described in reference to a 2-dimensional fingerprint image, one skilled in the art will appreciate that embodiments of the invention may be modified for use with 3-dimensional fingerprint images. For example, one embodiment may involve 3-dimensional fingerprint image scans, minutiae points defined in 3-dimensional space, and simulated points are added based on methods modified for 3-dimensional space.

Returning to process 400, the method continues to step 412, where the ICP algorithm is used to register the first set of minutiae points and the second set of minutiae points. At least one set of minutiae points includes simulated points. In other embodiments of the invention, another registration method other than the ICP algorithm may be used to register multiple sets of minutiae points.

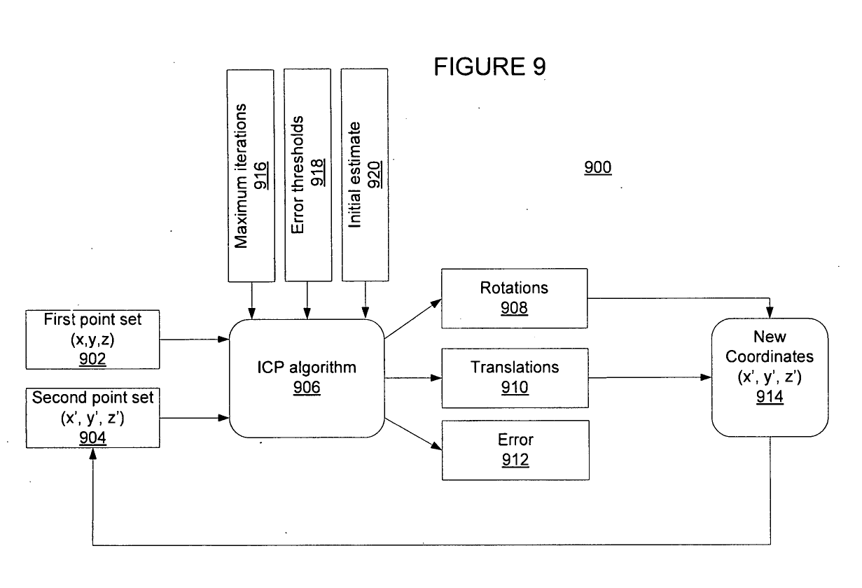

FIG. 9 is a diagram useful for understanding a general implementation of the ICP algorithm in one embodiment of the invention. The general ICP algorithm is an iterative process capable of reconciling two sets of points through an iterative process. The ICP algorithm 906 can handle 2-dimensional as well as 3-dimensional points. The ICP algorithm 906 takes as input a first point set 902 and a second point set 904. In each iteration, the ICP algorithm 906 calculates rotations 908 and translations 910 for second point set 904. The ICP algorithm 906 also uses the rotations 908 and translations 910 to create new coordinates 914 for second point set 904. The ICP algorithm 906 also calculates an error 912 which represents the distance between the first point set 902 and the new coordinates 914 for second point set 904. The new coordinates 914 are used as input in place of second point set 904 in the next iteration. At each iteration, the ICP algorithm 906 calculates new coordinates 914 for point list 904. A number of maximum iterations 916 and an error threshold 918 may be supplied to ICP algorithm 906. The ICP algorithm also takes as input an initial estimate 920 for the alignment of first point set 902 and second point set 904. The algorithm will converge if the initial estimate 920 is sufficiently close. Methods to calculate an initial estimate for the ICP algorithm are known in the art.

The ICP algorithm is an example of a point registration algorithm which does not use orientation information to register multiple sets of points. By registering multiple sets of minutiae points which include simulated points that simulate orientation information, the ICP algorithm uses the orientation information provided by the location of the simulated points in the registration process.

Returning to process 400, the method continues to step 414, where the minutiae points are rotated and translated based on the result of the registration step 412. In one embodiment of the invention, points in a second set of minutiae points are rotated and translated based on a transformation produced by the registration step 412.

The method continues to step 416, where the first set of minutiae points and the second set of minutiae points are combined to form a single fingerprint template. In one embodiment of the invention, the fingerprint template includes the simulated points added in step 410. In another embodiment of the invention, the fingerprint template includes only the original minutiae points.

The process continues to optional step 418, where simulated points are removed from the fingerprint template. In one embodiment of the invention, simulated points added to a set of minutiae points remain in the final fingerprint template. In another embodiment of the invention, some or all of the simulated points are removed from the final fingerprint template. In one embodiment of the invention, a method is used to keep track of whether points in a set of minutiae points are simulated points or original minutiae points extracted from the fingerprint image. In one embodiment of the invention, the simulated points are removed from the first and second set of minutiae points after registration step 412 but before combining step 416. The method may involve booleans, arrays, tables, databases, or any other data structure. In step 420, the process terminates.

In one embodiment of the invention, a fingerprint template is synthesized from two fingerprint images. However, it would be recognized by one skilled in the art that embodiments of the invention include methods to synthesize a fingerprint template from more than two fingerprint images. Even if an algorithm for registering two sets of points is used, such as the ICP algorithm, more than two fingerprint images can be used to synthesize a fingerprint template. For example, multiple sets of minutiae points from multiple fingerprint images can be registered first registering two sets, then iteratively registering the combined sets with another set of minutiae points. In one embodiment of the invention, when more than two fingerprint images are used to synthesize a fingerprint template, simulated points are added based on the location and orientation of minutiae points before registration of a fingerprint image with already-combined sets of minutiae points. Furthermore, while the ICP algorithm is used in the exemplary embodiments, another registration algorithm may be used to reconcile the sets of minutiae points.

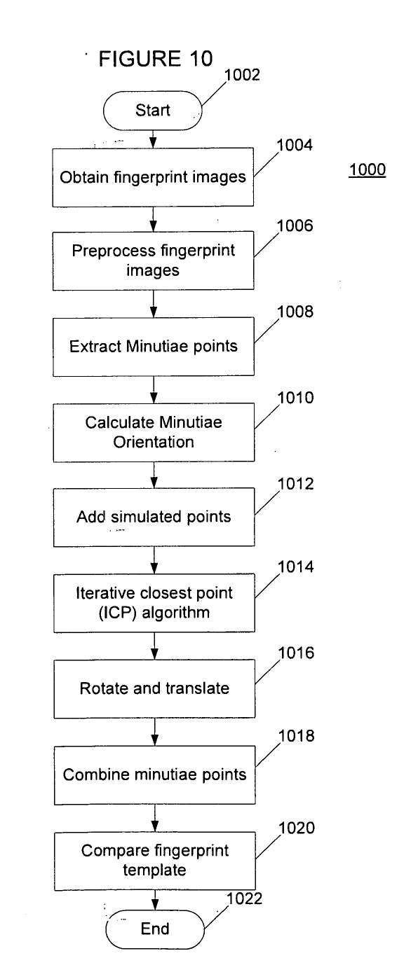

Embodiments of the invention also relate to fingerprint recognition. FIG. 10 is a flowchart useful for understanding fingerprint recognition using synthesized fingerprint templates according to embodiments of the invention. Process 1000 in FIG. 10 begins at step 1002 and continues with step 1004. In step 1004, multiple digital fingerprint images of the same fingerprint are obtained. The method continues to steps 1006-1018, resulting in a combined set of minutiae points in accordance with the embodiment described in FIG. 4. In one embodiment of the invention, the fingerprint are obtained from latent fingerprints, or any other source of partial fingerprint images or fingerprint images of poor quality. Although this embodiment is functional using multiple fingerprint images of good quality, combining fingerprint features is less important when comparing good quality fingerprint images with good quality fingerprint templates.

The method continues to step 1020, where the combined minutiae points are compared to stored fingerprint templates to locate a match. Methods of comparing are known in the art, and may include both computational and manual steps. For example, fingerprint templates which are a close match to the combined minutiae points based on a set threshold may be automatically selected for manual examination by a fingerprint expert. In embodiments of the invention, the stored fingerprint templates are stored in a database associating fingerprint templates with individuals. In one embodiment of the invention, the fingerprint recognition method is used for fingerprint verification. In another embodiment of the invention, the fingerprint recognition method is used for fingerprint identification.

Embodiments of the invention also relate to a system for fingerprint enrollment. Fingerprint enrollment describes the process by which a fingerprint data is associated with a user. This may include fingerprint template synthesis and associating the fingerprint template with the user. In one embodiment of the invention, a system for fingerprint enrollment comprises a fingerprint sensor, a computing means for fingerprint template synthesis, and a computer-readable storage medium for storing the fingerprint template. The fingerprint sensor is used to take multiple fingerprint images of the same finger of the user. These multiple fingerprint images are used to synthesize a fingerprint template according to the embodiments of the method described in FIG. 4. The synthesized fingerprint template is stored on the computer-readable storage medium. In one embodiment of the invention, the computer-readable storage medium is a database. Once a user is enrolled using the fingerprint enrollment system, the fingerprint template may be used for fingerprint verification or fingerprint identification.

In one embodiment of the invention, the fingerprint sensor is a solid-state fingerprint sensor. The computing mean may be a software, hardware or solid-state device. In one embodiment of the invention, the computer-readable storage medium is a solid-state memory device. In one embodiment of the invention, the fingerprint sensor, the computing means, and the computer-readable storage device are included in one product, such as a mobile computer, a cell phone, an alarm system, or any other device where fingerprint verification is desirable. In another embodiment of the invention, the system is implemented over multiple devices. The devices may be physically joined. In another embodiment of the invention, the multiple devices are joined over a network, such as a wireless network, an intranet, the internet, and any other kind of network.

All of the systems, methods and algorithms disclosed and claimed herein can be made and executed without undue experimentation in light of the present disclosure. While the invention has been described in terms of preferred embodiments, it will be apparent to those of skill in the art that variations may be applied to the systems, methods and sequence of steps of the methods without departing from the concept, spirit and scope of the invention. More specifically, it will be apparent that certain components and/or steps may be added to, combined with, or substituted for the components and/or steps described herein while the same or similar results would be achieved. All such similar substitutes and modifications apparent to those skilled in the art are deemed to be within the spirit, scope and concept of the invention as defined.

We claim:

1. A method for fingerprint template synthesis from multiple fingerprint images comprising:
extracting a first set of minutiae points from a first fingerprint image;
extracting a second set of minutiae points from a second fingerprint image;
calculating the orientation of a plurality of minutiae points selected from the first set of minutiae points based on the first fingerprint image;
adding simulated points to the first set of minutiae points, wherein simulated points are created based on the location and orientation of minutiae points in the plurality of minutiae points;
registering the first set of minutiae points and the second set of minutiae points; and
combining the first set of minutiae points and the second set of minutiae points into a fingerprint template.

2. The method of claim 1, further comprising the steps of:
calculating the orientation of a second plurality of minutiae points selected from the second set of minutiae points based on the second fingerprint image; and
adding simulated points to the second set of minutiae points, wherein simulated points are created based on the location and orientation of minutiae points in the second plurality of minutiae points.

3. The method of claim 1, wherein the iterative closest point (ICP) algorithm is used to register the first set of minutiae points and the second set of minutiae points.

4. The method of claim 1, wherein the fingerprint template includes the simulated points.

5. The method of claim 1, wherein combining the first set of minutiae points and second set of minutiae points comprises rotating and translating minutiae points.

6. The method of claim 1, further comprising preprocessing at least one of the first fingerprint image and the second fingerprint image to enhance ridge lines, and using the ridge lines to calculate the orientation of minutiae points.

7. The method of claim 6, wherein said preprocessing comprises using inpainting techniques to detect and fill in voids.

8. The method of claim 1, further comprising creating the simulated points based on the orientation and type of said minutiae points.

9. The method of claim 8, wherein:
the type of minutia point is a ridge ending,
the orientation of the ridge ending is the angle of a line of orientation connecting the ridge ending and an end point, the end point determined by tracing the ridge line in a direction away from the ridge ending for a predetermined distance, and
simulated points are created at selected pixels lying on the line of orientation between the ridge ending and the end point.

10. The method of claim 9, wherein the predetermined distance is 5 to 10 pixels.

11. The method of claim 9, wherein the selected pixels comprise every pixel lying on the line of orientation between the ridge ending and the end point.

12. The method of claim 8, wherein:
the type of minutia point is a bifurcation point,
the orientation of the bifurcation point is the angle of a line of orientation bisecting the angle between a first line and a second line, the first line connecting the bifurcation point and a first end point determined by tracing a first ridge of the bifurcation in a direction away from the bifurcation point for a first predetermined distance, and the second line connecting the bifurcation point and a second end point determined by tracing a second ridge of the bifurcation in a direction away from the bifurcation point for a second predetermined distance; and
simulated points are created at selected pixels lying on the line of orientation within a third predetermined distance of the bifurcation point.

13. The method of claim 12, wherein the first predetermined distance and the second predetermined distance are 5 to 10 pixels.

14. The method of claim 12, wherein the selected pixels comprise every pixel lying on the line of orientation within the third predetermined distance of the bifurcation point.

15. A method for fingerprint recognition from multiple fingerprint images comprising:
obtaining a first fingerprint image;
obtaining a second fingerprint image;
extracting a first set of minutiae points from the first fingerprint image;
extracting a second set of minutiae points from the second fingerprint image;
calculating the orientation of a plurality of minutiae points selected from the first set of minutiae points based on the first fingerprint image;
adding simulated points to the first set of minutiae points, wherein simulated points are created based on the location and orientation of minutiae points in the plurality of minutiae points;
registering the first set of minutiae points and the second set of minutiae points;
combining the first set of minutiae points and the second set of minutiae points; and
comparing the combined minutiae points to stored fingerprint templates to locate a match.

16. The method of claim 15, further comprising the steps of:
calculating the orientation of a second plurality of minutiae points selected from the second set of minutiae points based on the second fingerprint image; and
adding simulated points to the second set of minutiae points, wherein simulated points are created based on the location and orientation of minutiae points in the second plurality of minutiae points.

17. The method of claim 15, wherein the iterative closest point (ICP) algorithm is used to register the sets of minutiae and simulated points.

18. The method of claim 15, wherein combining the sets of minutiae points comprises rotating and translating minutiae points from the first set of minutiae and the second set of minutiae points.

19. The method of claim 15, wherein the at least one of the first fingerprint image and the second fingerprint image is preprocessed to enhance ridge lines and the ridge lines are used to calculate the orientation of minutiae points.

20. The method of claim 15, wherein the simulated points are created based on the orientation and type of a minutia point.

21. A system for fingerprint enrollment comprising:
a fingerprint sensor;
a computing means for synthesizing a fingerprint template from multiple fingerprint images of the same finger by extracting a first set of minutiae points from a first fingerprint image, extracting a second set of minutiae points from a second fingerprint image, calculating the orientation of a plurality of minutiae points selected from the first set of minutiae points, adding simulated points to the first set of minutiae points based on the location and orientation of the minutiae points in the plurality of minutiae points, registering the sets of minutiae points, and combining the sets of minutiae points into a fingerprint template, said fingerprint images being taken from the fingerprint sensor; and
a computer-readable storage medium for storing the fingerprint template.

22. The system of claim 21, wherein the computing means is further configured to:
calculate the orientation of a second plurality of minutiae points selected from the second set of minutiae points, and
add simulated points to the second set of minutiae points based on the location and orientation of the minutiae points in the second plurality of minutiae points.

23. The system of claim 21, wherein at least one of the fingerprint sensor, the computing means, and the computer-readable storage medium is a solid-state device.
